(19) United States
(12) Patent Application Publication
(10) Pub. No.: US 2017/0237365 A1
(43) Pub. Date: Aug. 17, 2017

(54) Thread Shaped Contact Electrification Fiber

(71) Applicant: The Curators of the University of Missouri, Columbia, MO (US)

(72) Inventors: Jae Wan KWON, Columbia, MO (US); Quang NGUYEN, Columbia, MO (US); Baek Hyun KIM, Columbia, MO (US)

(21) Appl. No.: 15/504,565

(22) PCT Filed: Aug. 17, 2015
(86) PCT No.: PCT/US15/45474

§ 371 Date: Feb. 16, 2017

Related U.S. Application Data
(60) Provisional application No. 62/038,666, filed on Aug. 18, 2014.
(60) Provisional application No. 62/131,012, filed on Mar. 10, 2015.

(51) Int. Cl. H02N 1/04; D03D 15/02; D03D 1/00; A41D 1/00; A41D 31/00

(52) U.S. Cl. CPC H02N 1/04; A41D 1/002; A41D 31/00; D03D 1/0088; D03D 15/02

(57) ABSTRACT

An electrostatic power generation fiber comprising a thread-shaped core that comprises a conductive component; a charge building-inducting-tunneling layer on the core that comprises a contact electrification material. An embodiment of the present invention is directed to an electrostatic power generation fiber comprising: (a) a thread-shaped core that comprises a conductive component; and (b) a charge building-inducting-tunneling layer on the core that comprises a contact electrification material; wherein electrical charge, formed via contact electrification of the charge building-inducting-tunneling layer, travels along the core, which during electrostatic power generation the core is a constituent of an electrical network.

### CROSS-REFERENCE TO RELATED APPLICATIONS

The present application is a PCT application claiming the benefit of U.S. Provisional Application 62/038,666, filed Aug. 18, 2014, and U.S. Provisional Application 62/131,012, filed Mar. 10, 2015, which are incorporated herein by reference in their entirety.

### FIELD OF INVENTION

The present invention is directed to contact electrification fibers that may be incorporated into textiles and garments for electrical power generation and methods of making such contact electrification fibers.

### BACKGROUND OF INVENTION

In recent years, there has been remarkable growth in the diversity and application of small electronics, as evidenced by the increasing global prevalence of portable systems. Amazing advancements of micro/nanotechnologies have resulted in the emergence of new applications, including novel wearable electronics, the importance of which is on the rise. [13-20] There have been numerous attempts to develop various alternative energy harvesting technologies to power portable electronic devices [1, 2] by harvesting mechanical energy from human activities, wind, and sound vibration. In particular, piezoelectric devices have been extensively studied because of their ability to directly convert mechanical energy to electrical energy. Although promising [3-5], the power produced by piezoelectrics is so low that they are not satisfactory for many applications.

Currently, one of the most common power sources for mobile electronics is the lithium-ion battery, but it is not appropriate for wearable electronics because of the potential fire hazard of lithium in air, in addition to the large size and heavy weight. Another drawback is the requirement for frequent recharging. Although various alternative methods of harvesting power from solar, [21] wind, [22] mechanical vibration, [23] etc. have been considered; size and weight are not easily reduced in order to be compatible with wearable electronics. Many energy conversion mechanisms require certain devices and materials which cannot be miniaturized to be unnoticeably hidden in textiles.

Another method of generating electrical power from mechanical energy and vibration that has been recently used is contact electrification. When two materials are brought into contact with each other and separated, they become electrically charged, one positive and the other negative. The electrostatic charge imbalance between materials drives charges from one material to the other. Examples of contact electrification generators include a multilayered triboelectric nanogenerator [6], a nanoparticle-enhanced triboelectric nanogenerator [7], etc. [8-11]. However, all these approaches resulted in relatively large power sources to attach to clothes.

In view of the foregoing, a need still exists for an energy harvesting technology that is readily incorporated into textiles and garments, that does not have the power limitations of piezoelectrics, and that does not require relatively large and/or heavy devices being attached to the textile or garment.

### SUMMARY OF THE INVENTION

An embodiment of the present invention is directed to an electrostatic power generation fiber comprising:
(a) a thread-shaped core that comprises a conductive component; and
(b) a charge building-inducting-tunneling layer on the core that comprises a contact electrification material;
   wherein electrical charge, formed via contact electrification of the charge building-inducting-tunneling layer, travels along the core, which during electrostatic power generation the core is a constituent of an electrical network.

Another embodiment of the present invention is directed to textile comprising at least one of said electrostatic power generation fibers.

Yet another embodiment of the present invention is directed to a garment comprising said textile.

In yet another embodiment, the present invention is directed to a garment comprising at least one of said electrostatic power generation fibers.

In another embodiment, the present invention is directed to making a textile or garment comprising at least one of said electrostatic power generation fibers, wherein the method comprises weaving said at least one of said electrostatic power generation fibers into said textile or garment.

In still another embodiment, the present invention is directed to a method of preparing an electrostatic power generation fiber comprising forming a charge building-inducting-tunneling layer that comprises a contact electrification material on a thread-shaped core that comprises a conductive component.

### BRIEF DESCRIPTION OF THE DRAWINGS

FIG. 1 shows: (A) an SEM image of a contact electrification fiber embodiment having a core that is a copper line and charge building-tunneling layer that is PTFE on the core; (B) an SEM image of the PTFE surface after drying; (C) is a schematic drawing of a testing setup in touching mode; and (D) is a schematic drawing of a testing setup in dragging mode.

FIG. 2 are graphs showing touching mode measurement results of a contact electrification fiber like that shown in FIG. 1 contacted with (A) an aluminum test rod and (B) a stainless steel test rod.

FIG. 3 are graphs showing touching mode measurement results of three contact electrification fibers like that shown in FIG. 1 twisted together and contacted with (A) an aluminum test rod and (B) a stainless steel test rod.

FIG. 4 are graphs showing dragging mode measurement results of a contact electrification fiber like that shown in FIG. 1 contacted with (A) an aluminum test rod and (B) a stainless steel test rod (B).

FIG. 5 shows: (A) a schematic diagram of the fabrication contact electrification fiber embodiment having a core that comprises cotton thread, which comprises cotton fibers, and carbon particles and a charge building-tunneling layer that is silicone; (B) a SEM image of a single cotton fiber; (C) a SEM image of a cotton thread comprising a multiplicity of cotton fibers; (D) a SEM image of a contacting electrification fiber embodiment having a core that comprises cotton thread, which comprises cotton fibers, and carbon particles and a charge building-tunneling layer that is silicone.

FIG. 6 shows photographs of a thin and thick cotton textiles, (A) and (B) respectively, with contact electrification fibers like that of FIG. 5 woven therein (in a simple line pattern with needles shown) and attached to copper electrode.

FIG. 7 are schematic diagrams depicting rubbed (A) and tapped (B) modes of a contact electrification fiber like that of FIG. 5 woven into textiles like that of FIG. 6.

FIG. 8 are graphs showing output voltages and currents as a function of time for textiles like that of FIG. 6 (having carbon active cotton thread) were rubbed (A and B) and tapped (C and D) with PTFE.

FIG. 9 shows (A) a photograph of 10 blinking LEDs powered by electrostatic charges generated by contract electrification of the carbon active cotton thread and (B) a graph of its time-dependent open-circuit voltage.

FIG. 10 shows an electric field (V/m) between carbon-activated thread (bottom) and the PTFE sheet (top) when the gaps between them with a potential of −60.9 V are (A) 2 cm and (B) 2 mm.

FIG. 11 is a graph showing the results of energy-dispersive x-ray spectroscopy (EDS) of cotton thread and carbon-activated cotton thread.

FIG. 12 is (A) a graph open-circuit voltage of two lines of carbon-activated thread woven in thick textile as set forth in (B) photograph, wherein the distance between the two lines was 3 cm and a load of 100 MΩ was connected with an oscilloscope and the carbon-activated thread.

FIG. 13 is SEM images of different porous PTFE with micro/nano structures after high temperature treatment.

### DETAILED DESCRIPTION OF INVENTION

The present invention is directed generally to an energy harvesting technology that may be readily incorporated into textiles and garments. Specifically, one embodiment of the present invention is directed to an electrostatic power generation fiber, which may also be referred to herein as a contact electrification fiber or a thread-shaped power generator. Advantageously, one or more such electrostatic power generation fibers may be readily incorporated into textiles, fabrics, and/or garments. Further, said electrostatic power generation fibers are not subject to the power limitations of piezoelectrics, nor do they require relatively large and/or heavy devices being attached to the textile or garment.

By using one or more of the above-described electrostatic power generation fibers, the phenomenon of contact electrification may be exploited to harvest energy from human activities and/or types of induced contact or motion (e.g., wind). Further, it is believed that the electrostatic power generation fibers will contribute to various fields of study including flexible and wearable electronics in many applications.

### Contract Electrification

Conductive materials have significant electron mobility and consequently tend to maintain an electrical equilibrium. In nonconductive materials, such as PTFE and PDMS, however, the low mobility of electrons does not provide for rapid recombination of charge imbalance. If contacted or rubbed, a dielectric may either give up electrons or capture free electrons. In general, PTFE accepts free electrons and becomes negatively charged by nature of the outer valence orbit. [36] Those accumulated negative charges attract positive charges and try to rapidly eliminate the imbalance by recombination of the opposite charges. Since rubbing or repeated contact produces a large electric field gradient in nonconductive materials, there is a rapid release of electrons when discharge occurs. [37]

The phenomenon of contact electrification effect has been used to generate electrical power from mechanical energy and vibration. As described above, when two materials are brought into contact with each other and separated, they become electrically charged, one positive and the other negative. The electrostatic charge imbalance between materials drives charges from one material to the other. Factors that affect the charge transfer process include the surface condition and the contact area between materials. Additionally, many factors can affect the performance of contact electrification devices. For example, the charge density cannot be higher than the dielectric breakdown of the active medium (e.g., air). If the voltage generated is higher than the threshold voltage for air breakdown, charge is conducted through the active surfaces. Thus, in one embodiment of the present invention, it is contemplated that the active medium may be something with a larger dielectric constant than air. Moreover, as the charge builds up, the electric field decreases the possibility of future charge to be exchanged. Further, charge leaking to the surrounding environment may also affect the performance of a device. Charge leaking strongly depends on the active medium (e.g., in the case of air, humidity and temperature affect charge leaking).

### Electrostatic Power Generation Fibers

In an embodiment of the present invention, an electrostatic power generation fiber comprises: (a) a thread-shaped core that comprises a conductive component; and (b) a charge building-inducting-tunneling layer on the core that comprises a contact electrification material. As indicated above, electrical charge may be formed via contact electrification of the charge building-inducting-tunneling layer and said electrical charge travels along the core, which during electrostatic power generation the core is a constituent of an electrical network.

Thread-Shaped Core

The conductive component of the thread-shaped core comprises a conductive material and has a resistivity generally considered to be that of an electrical conductor. Further, the conductive component comprises a conductive material. Such conductive materials typically have a resistivity in a range of about 0.01 Ω·cm to about 10 MΩ·cm. Examples of conductive materials include conductive metal elements (e.g., copper, aluminum, silver, gold, titanium, nickel, iron), conductive metallic alloys), conductive non-metallic elements (e.g., carbon), conductive compounds (e.g., conductive polymers such as poly(fluorene)s, polyphenylenes, polypyrenes, polyazulenes, polynaphthalenes, poly(acetylene)s (PAC), poly(p-phenylene vinylene) (PPV), poly(pyrrole)s (PPY), polycarbazoles, polyindoles, polyazepines, polyanilines (PANI), poly(thiophene)s (PT), poly(3,4-ethylenedioxythiophene) (PEDOT), poly(p-phenylene sulfide) (PPS)), a mixtures of the foregoing, and combinations thereof.

Wire-Like or Solid Core

In one embodiment, the thread-shaped core consists of the conductive component. In such an embodiment, the conductive component may comprise other constituents than the conductive material. For example, the core may be an extrusion comprising a material providing structural properties in addition to a conductive material. Alternatively, the conductive component may consist of the conductive material. Regardless of whether the component comprises, or consists of, the conductive material, such embodiments of the electrostatic power generation fiber may be referred as having a “wire-like” or “solid” core. Despite the use of the foregoing terms, it is to be noted that the core need not actually be solid. Rather, it could have appropriate or desirable non-solid or hollow shape such as a tube. Whether solid or hollow, the core may have essentially any appropriate or desirable cross-sectional shape. For example, the cross-sectional shape may be circular, polygonal, oval, dog-bone, concertina, star, collapsed tube trilobal, lobular, ribbon, and/or Y shaped. Typically, the thread-shaped core has a maximum cross-sectional distance in a range of about 0.1 μm to about 10 cm. The larger diameters (e.g., from about 1 cm to about 10 cm) are contemplated for use typically in large-scale applications such as construction materials for buildings, and infrastructure such as bridges.

In such a wire-like core embodiment, the conductive material may be selected from the group consisting of conductive metal elements, conductive metallic alloys, carbon fiber, conductive polymer fiber, and combinations thereof. In one particular embodiment, the thread-shaped core is a copper wire having a circular cross-section and a diameter in a range of about 0.1 μm to about 10 cm.

Thread-Like Substrate Supporting Conductive Material

In one embodiment, the thread-shaped core further comprises a substrate component to which the conductive component is secured. In one such embodiment the substrate component is a thread. The thread may, for example, have a maximum cross-sectional distance in a range of about 0.1 μm to about 10 cm.

Thread Comprises Fibers

The thread comprises a thread material selected from the group consisting of natural fibers, man-made fibers, and combinations thereof. Exemplary natural fibers include vegetable fibers, animal fibers, and combinations thereof. More specific examples of vegetable fibers include cotton, hemp, jute, flax, ramie, sisal, bagasse, and combinations thereof. Exemplary animal fibers include silkworm silk, spider silk, sinew, catgut, wool, sea silk, hair, fur, and combinations thereof. Exemplary man-made fibers include semi-synthetic fibers, synthetic fibers, carbon fibers, fiberglass, metallic fibers, and combinations thereof. Specific examples of semi-synthetic fibers include rayons, cellulose diacetate, cellulose triacetate. Specific examples of synthetic fibers include nylon, PBT polyester, PET polyester, aromatic polyamids (e.g., TWARON®, KEVLAR®, and NOMEX®), polyethylene, elastomers (e.g., SPANDEX®), polyurethane, elastolefin, acrylic polyesters, coextruded fibers of the foregoing polymers, and combinations thereof.

The foregoing fibers making up the thread material may be discontinuous fibers having an aspect ratio (ratio of fiber length to diameter) in a range about 20 to 200, or may be continuous fibers having an aspect ratio greater than 200 (e.g. up to about 10,000,000 for a 1 km-long fiber with 100 micron in diameter), or a combination of the discontinuous and continuous fibers.

Conductive Component Secured to Substrate

The conductive component may be essentially any configuration provided it may be secured to the substrate. For example, in one embodiment, the conductive component may comprise conductive fibers (e.g., metallic or conductive polymer), included with the aforementioned substrate fibers in the making of a thread.

Alternatively, the conductive component may comprise particulate. In such embodiments, the particulate is of a size that is typically in a range of about 1 nm to about 500 μm. Exemplary particulate include carbon particles, carbon nanotubes, metal nanoparticles, metal nanowires, micrometer sized metal particles, conductive polymer, graphite, graphene, semiconductor, and combinations thereof.

In one embodiment, the particulate is carbon particles and the thread comprises cotton fibers.

In a further embodiment, the conductive component is secured to the substrate component with binding component. In particular, the binding component may comprise a polymer. Exemplary polymers include poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof. Further, natural polymers/adhesives may be used to secure the conductive component alone or in conjunction with the foregoing synthetic polymers. Examples of such natural adhesives or polymers include vegetable starch (dextrin), natural resins, milk protein casein, animal glues (e.g., hide glue, bone glue, fish glue, rabbit skin glue), natural lignin, etc.

Charge Building-Inducting-Tunneling Layer

As set forth above, the electrostatic power generation fiber comprises a charge building-inducting-tunneling layer on the above-described core. The charge building-inducting-tunneling layer has a dielectric strength in the range of about 1 MV/m to about 2000 MV/m. Further, the charge building-inducting-tunneling layer comprises a contact electrification material. The aforementioned dielectric strength is a function, in part, of the dielectric constant (or relative permittivity), ∈ᵣ, of the contact electrification material. Typically, the contact electrification material is selected such that it has a dielectric constant (∈ᵣ) in a range of about 1 to about 100. Exemplary contact electrification materials include poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof.

In one embodiment, the contact electrification material is polytetrafluorethylene.

In addition to the dielectric constant of the contact electrification material, the dielectric strength of the charge building-inducting-tunneling layer depends upon its thickness. Typically, the layer has an average or nominal thickness in a range of about 5 nm to about 1 mm. Still further, the dielectric strength is affected by the porosity of the layer. Advantageously, the porosity of the layer is controlled to allow for electric charge built up on the layer to make its way to and through the core from where it can travel in an electrical network and do work. Specifically, the layer is formed with pores of sizes in a range of about 1 nm to about 500 μm.

Additionally, the surface of the building-inducting-tunneling layer is controlled to enhance or increase the charge building that occurs during contact electrification. In particular, in one embodiment the charge building-inducting-tunneling layer has a nano/micro scale surface morphology. Such surface morphology comprises features of a size in a range of about 1 nm to about 500 μm.

As indicated above, the present invention is also directed to a textile comprising at least one electrostatic power generation fiber. Such textile may be used in the making of a garment. Alternatively, garments may comprise at least one electrostatic power generation fiber. Still further, the at least one electrostatic power generation fiber in such textiles or garments is a constituent of an electrical network. Depending upon the application, it may be desirable for such a textile or garment to comprise a multiplicity of the electrostatic power generation fibers. Still further, said electrostatic power generation fibers may be connected in series, in parallel, or both series and parallel.

In addition to garments, the electrostatic power generation fibers of the present invention may be incorporated into essentially any application that will be subjected to applicable contact, movement, vibration, etc. For example, the electrostatic power generation fibers may be incorporated into fabrics used in automobiles, furniture, flooring, flags, tents, awnings, etc.

The following disclosed embodiments are merely representative. Thus, specific structural, functional, and procedural details disclosed in the following examples are not to be interpreted as limiting.

### Examples

### Example 1. Copper Wire

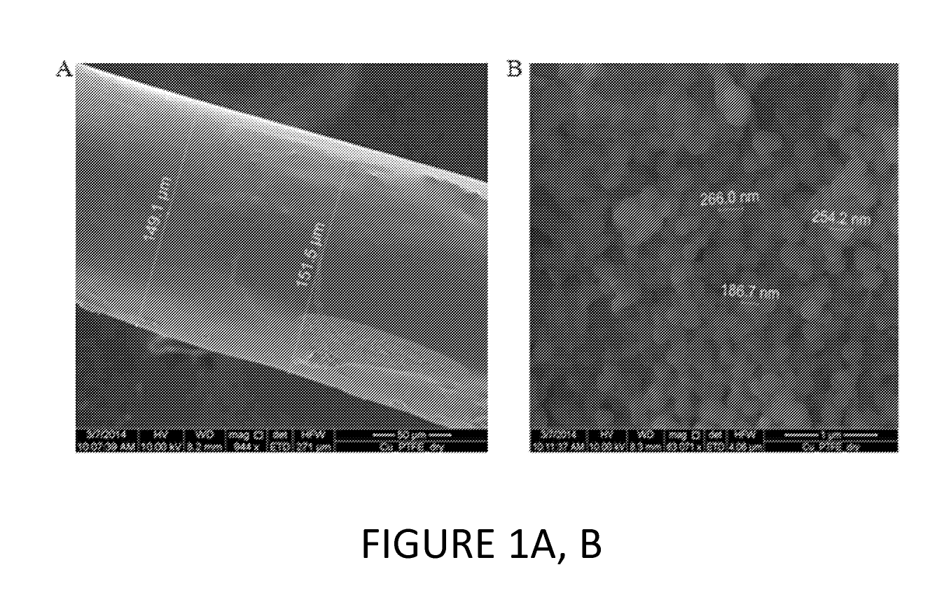

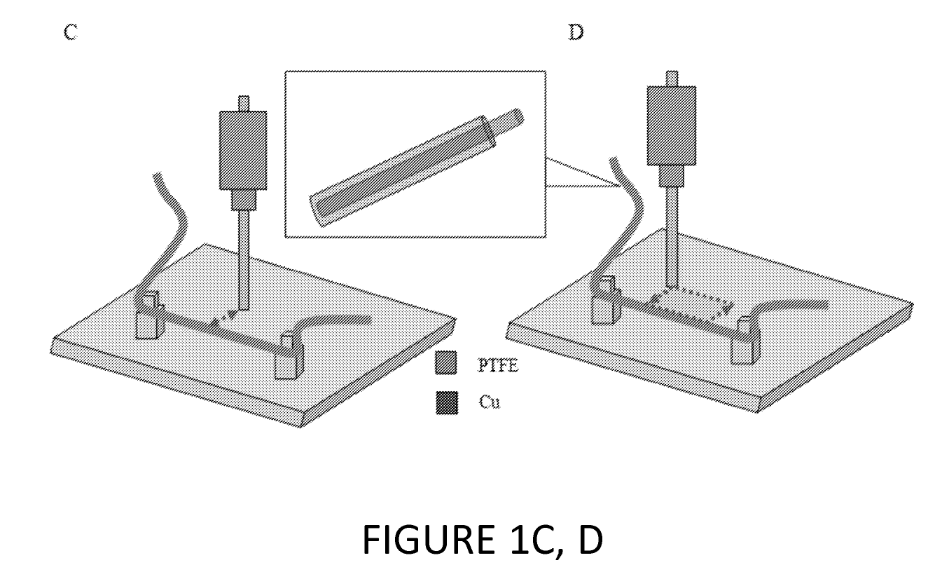

As illustrated in FIG. 1, a representative contact electrification fiber consists of a fine copper line (130 μm) coated with a very thin layer (10 μm) of polytetrafluoroethylene (PTFE). FIG. 1a shows a SEM image of the contact electrification fiber (i.e., a copper wire of diameter of 130 μm wrapped with PTFE nanoparticles). The diameter of the PTFE-coated wire is about 150 μm as shown. Copper was selected because of its high conductivity, mechanical strength, and cost efficiency. Using copper as a core of the fiber also allows high temperature treatment of the PTFE coating layer. The heating process helps PTFE particles bond more strongly to each other, which significantly reduces the possibility of them detaching from the final product in use. PTFE was selected as the contact electrification material because it is one of the most negative contact electrification materials. With a solution of 60% dispersion PTFE in water, a thin layer of PTFE was coated on fine copper wires using a dip coating method.

Samples were then completely dried overnight at room temperature. An SEM image (FIG. 1b) shows the relatively uniform sizes of PTFE particles on the surface after the drying process. Most of the PTFE particles are in the range from 150 nm to 300 nm in diameter. When heated, the wetting agent is evaporated away allowing PTFE particles to come in direct contact with each other. At about 400° C., the PTFE particles melted and bonded with each other forming a layer of PTFE material on copper wire.

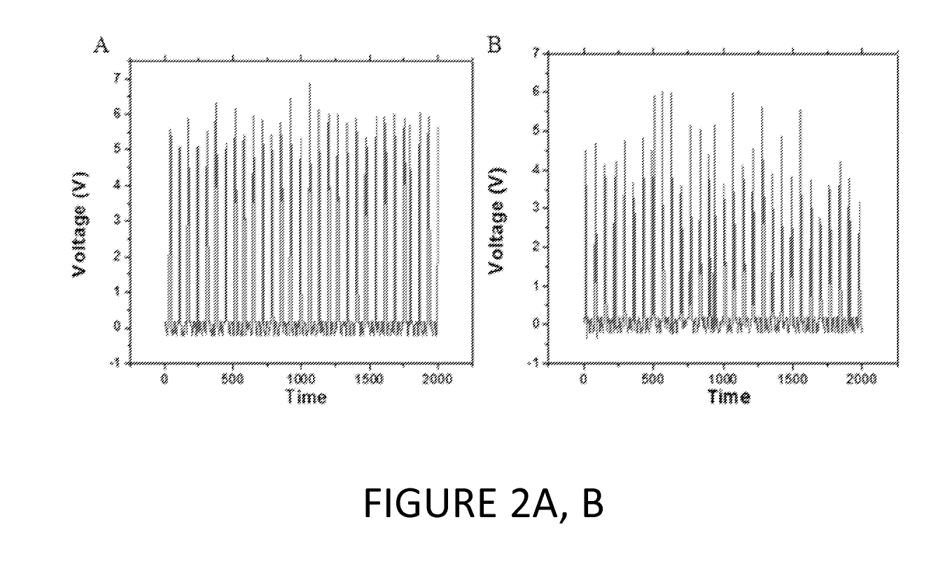

FIG. 1c, d shows a testing setup that included a motion-controlled testing rod for touching precisely and repeatedly the contact electrification fiber. In general, electrostatic charge generation can be classified into contact electrification (charging by repeated contact and separation of two different surfaces) and frictional electrification (charging by dynamic rubbing of two surfaces). [34] Compared to frictional electrification, contact electrification is relatively easy to analyze since there is no concern about the rubbing rate, temperature, and contact area on the static charge generation. The device was tested with two modes: touching and dragging. The testing rod moved straight back and forth to touch the fiber at a single point in the touch mode. The testing rod was dragged along the fiber repeatedly in the dragging mode. An aluminum rod and a stainless steel rod were used as the testing contacts. The output signals were measured using a Keithley 2601A source meter. FIGS. 2(a) and 2(b) are the output voltages of touching mode on aluminum rod and stainless steel rod, respectively. Data on aluminum testing rod have a consistent output voltage value between 5 and 6 volts. The maximum output voltage shows higher than 6 volts as shown in FIG. 2(a). Output voltages from the stainless steel were lower than that from the aluminum rod. Most of the peaks range from 3 to 5 volts. The maximum output reaches 6 volts. On the contact electrification series, PTFE is one of the materials that tends to acquire the most negative charge. On the other hand, aluminum and steel tend to acquire positive charge, or give up negative charge. In some studies, the metal work function can be used to explain their contact electrification properties [12]. With the work function of 4.28 eV, aluminum tends to give up electron easier than stainless steel which has the work function of 4.4 eV. The higher signal generated by aluminum test rod can be explained using this theory. The consistency of the data, however, depends on many factors such as the purity of the materials, the surface states and the surface roughness of the testing rods.

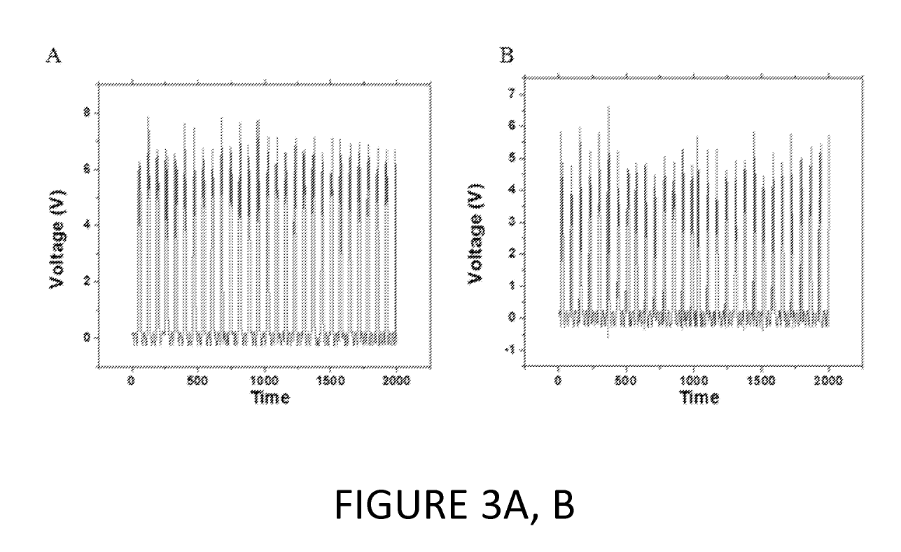

As many contemplated applications involve combining multiple contact electrification fibers together, the interaction between the fibers were studied. To investigate this property, three contact electrification fibers were twisted together. The samples were tested under the same set up as previously described (FIG. 1c, d). Data from FIG. 3a with aluminum testing rod has voltage generated around 6 volts, similar to the data of one wire. Data from FIG. 3b with stainless steel also have similar voltage range and consistency as that of a single fiber. With fibers twisted together, the testing rods touch only one wire at a time. The active areas or touching areas from both experiments are the same. The similarity of the data proves that the interaction or contact between the wires have negligible effect on the outcome value. Theoretically, contact between two surfaces of the same material also generates charged areas. However, some areas are positively charged and others are negatively charged. The net charge generated from this contact is therefore very small.

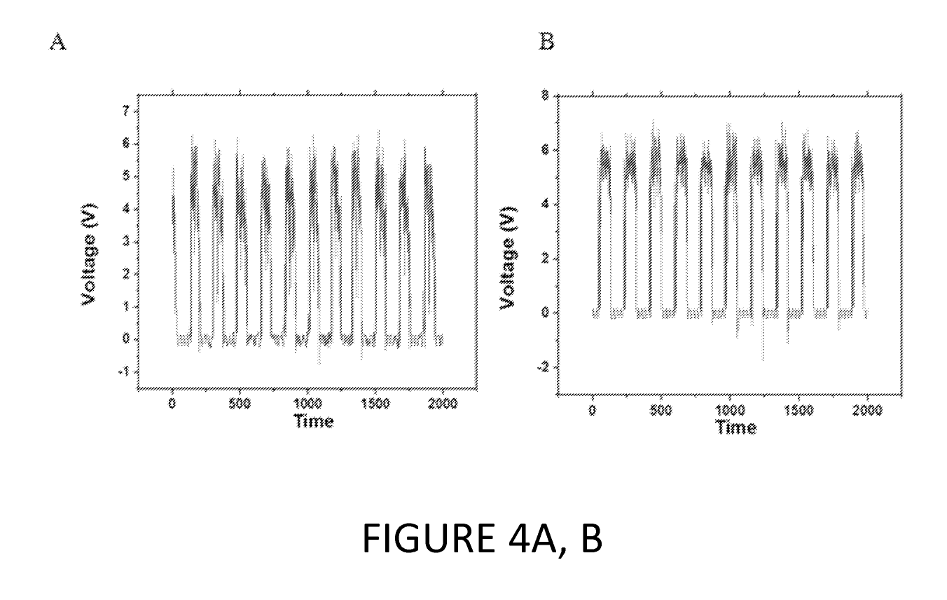

The basic test of touching the rods at a single position on the samples presents the base voltage generation by the fibers. To simulate how power would be generated in most applications, dragging mode was used. The testing rods are dragged along the fibers for certain time before being released. In everyday life activities, materials are not simply touched to each other. Most actions involve dragging surfaces of a material on surface of other materials for certain duration of time. Data of aluminum and stainless steel dragging on contact electrification fiber is presented in FIG. 4. Wider peaks corresponding to the dragging time appear on both data. The 6 volts value with the aluminum testing rod is consistent with touching mode. Voltage value with stainless steel is, however, more consistent compared with touching mode. Most of the peaks have values around 6V.

Since the testing rods and fibers were round in shape, their active areas were very small, e.g., less than 100 μm wide and several mm long. Thus, the 6V generated from the fibers is high. The considerable amount of power yield from one fiber promises a bright future. As hundreds of thousands fibers can be incorporated into one piece of cloth, the total power generated may be several order higher.

A power generation contact electrification fiber was successfully fabricated and tested. The maximum voltage measured from both touching mode and dragging mode was 6V. Voltage peaks from dragging mode were wider than touching mode and corresponded to the dragging time. The longer the interaction time between the test rod and the fiber, the wider the peaks were. Results showed that the contact electrification fiber's interaction between each other is negligible to the charge generation effect. It is contemplated that contact electrification fibers can be used in many applications to generate power for mobile devices and sensors. With the ability to harvest power from surrounding environment or everyday life activity, compact electrification fibers will have an impact on how we live in the future.

### Example 2. Cotton Threads

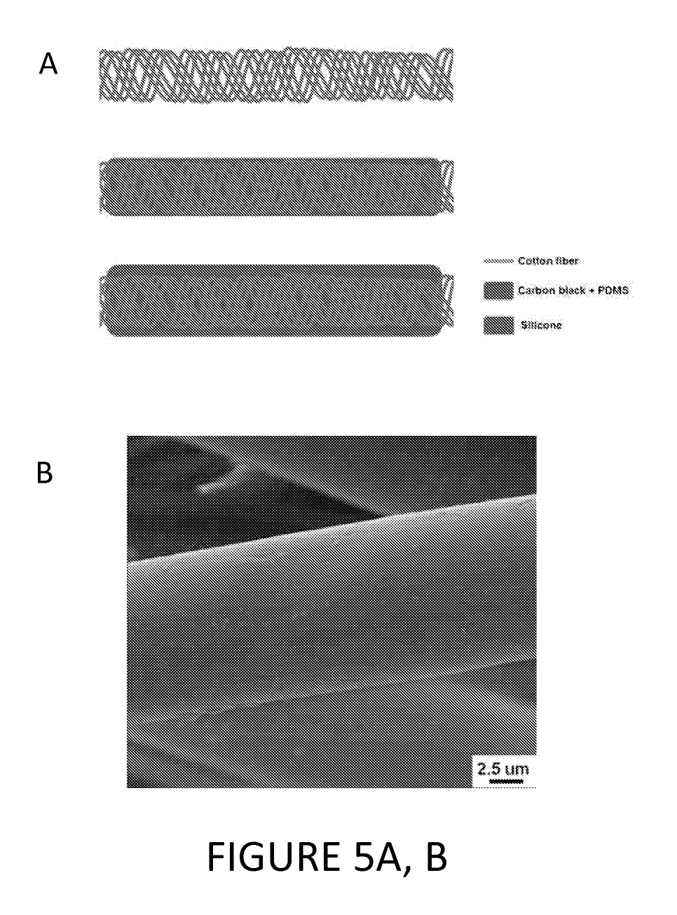

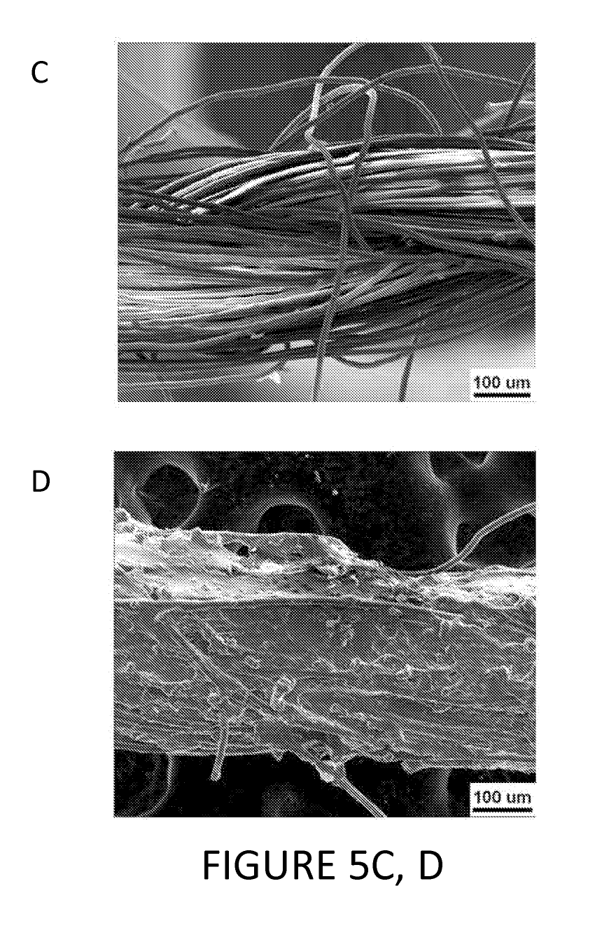

Among the fabrics used for textile and apparel manufacturing, cotton (natural cellulose) is the most commonly used material due to its processing simplicity, cost effectiveness, mechanical properties and overall comfort. In addition, various methods of treating cotton without losing cotton's unique set of physical properties have been broadly studied. [24-33] Therefore, cotton was used as a base substrate material for a thread-based wearable power harvester. Carbon black particles were embedded within cotton threads for enhancing electrical conductive properties. The structure of the thread-based power harvester is depicted in FIG. 5a. Carbon nanotubes (CNTs) are considered to be good conductive materials, but are very expensive. [35] A carbon-activated thread (CAT) power harvester, however, can be easily and cost-effectively produced with standard cotton materials imbued with carbon black particles. Polydimethylsiloxane (PDMS) may also be used to enhance the stability of carbon black particles in the thread structure under continuous mechanical forces and friction generated by rubbing and contacting. A thin layer of carbon black particles mixed with PDMS (MG chemicals, Canada) preserves the flexibility, elasticity and conductivity of the textile threads to a great extent, which makes them ideal for application in electronic textiles. When this mixture was applied on cotton thread, the resistance was 255.3 kΩ over a distance of 3 cm.

FIG. 5 also shows scanning electron microscope (SEM) images of the carbon-activated thread power harvester built on cotton threat. Normal cotton thread consists of multiple fibers, in which a single fiber has an average diameter of 12.07 μm, estimated by the SEM image in FIG. 5b. Moreover, the diameters of normal cotton thread and carbon-activated thread are 372.45 μm and 369.57 μm, respectively. Since normal cotton thread has a lot of empty space among the fibers (FIG. 5c), and the mixture of carbon black particles and PDMS fills those spaces (FIG. 5d), the diameters of each are almost the same.

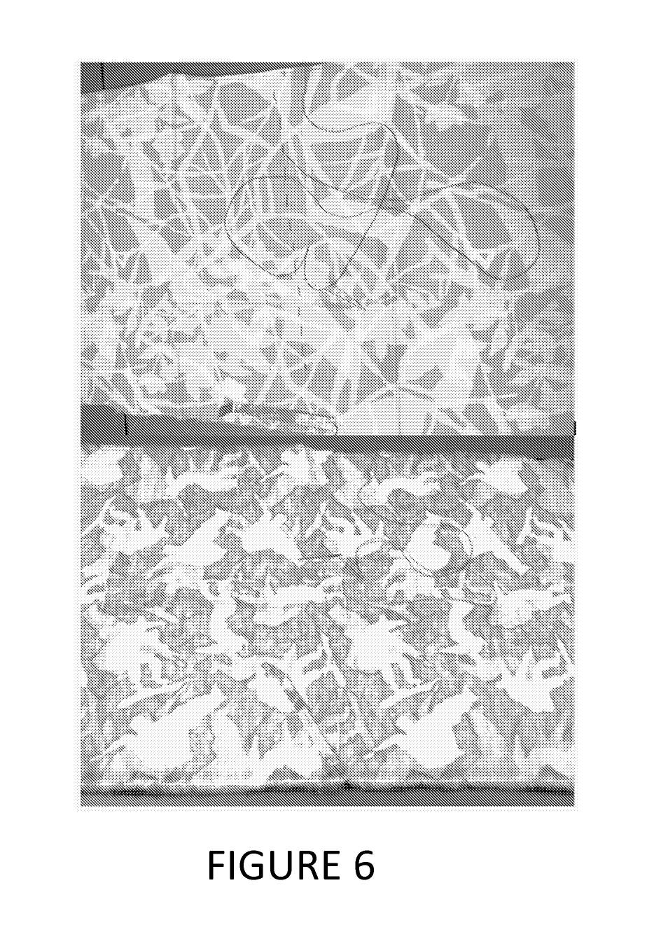

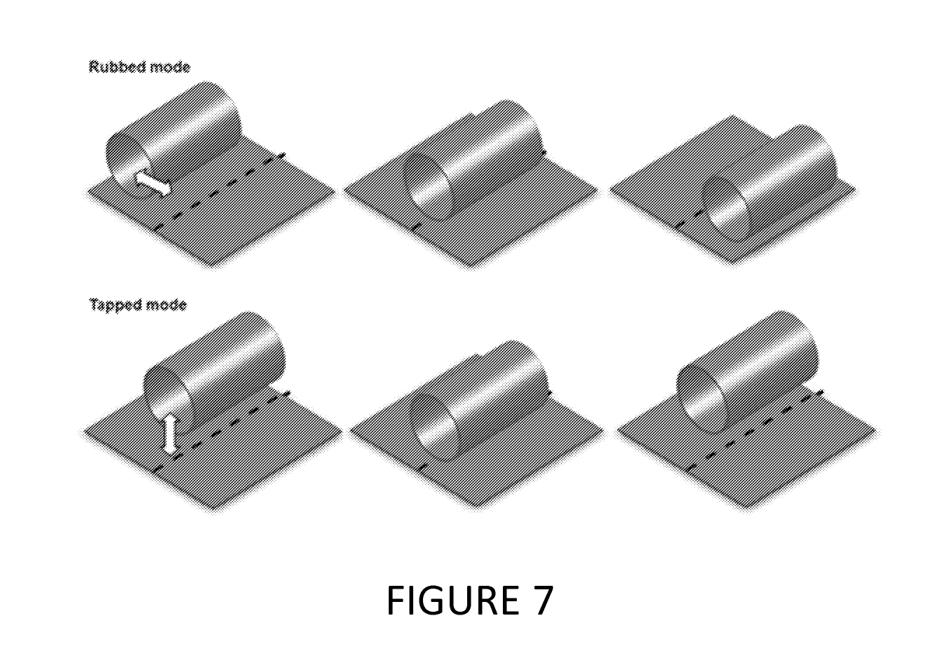

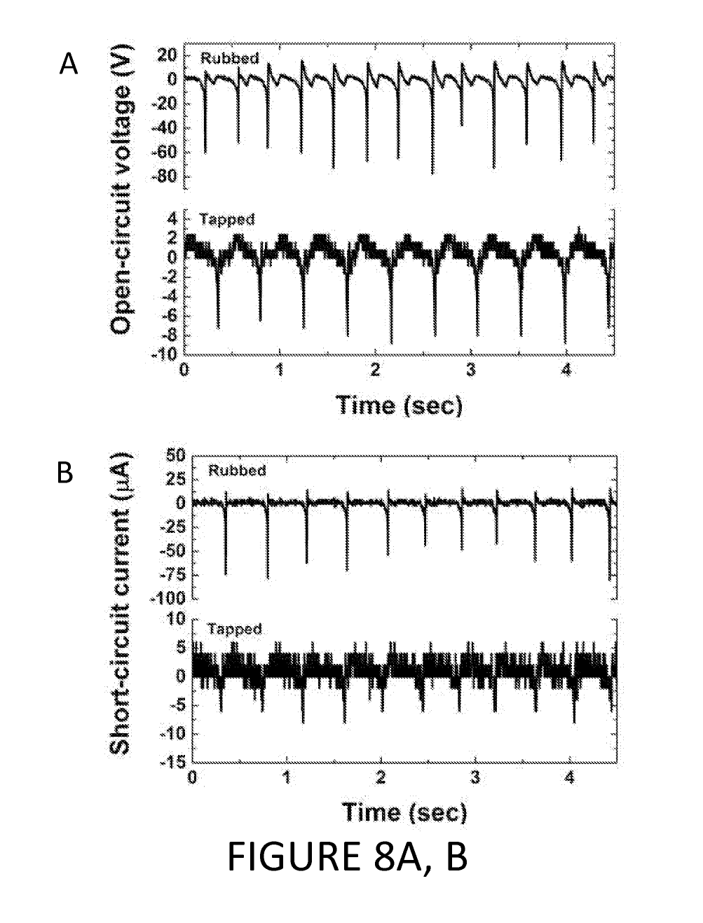

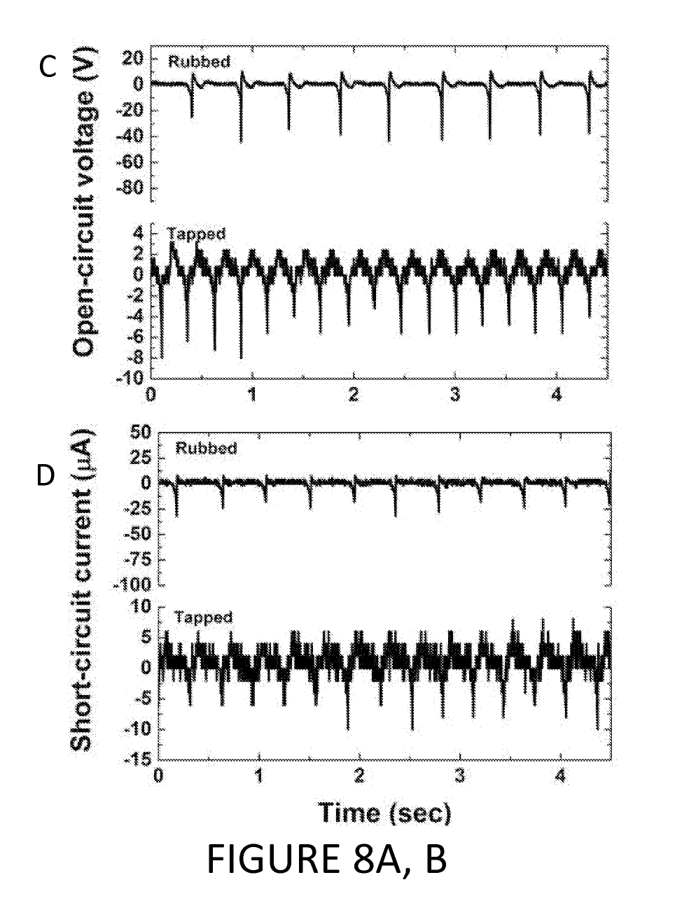

Carbon-activated thread power harvesters were woven into cloth for testing as shown in FIG. 6. Power outputs from each cloth were characterized by tapping or sweeping the surface with a PTFE sheet. For easy handling and testing with the PTFE sheet, a large cylindrical plastic tube wrapped with a PTFE sheet was used as illustrated in FIG. 7. The applied sweeping/tapping frequency was approximately 2˜4 Hz. FIG. 8 shows the outputs of time-dependent open-circuit voltages and short-circuit currents that occurred when the carbon-activated thread was rubbed or tapped with PTFE. The carbon-activated thread attracts electrons while in contact with PTFE. The rubbed mode on thick cotton textile has an average open-circuit voltage of approximately −60.9 V, while the tapped mode has an average open-circuit voltage of −7.76 V, as shown in FIG. 8a. The thick cotton textile with rubbed mode shows a short-circuit current of −61.08 μA, while the tapped mode has an average short-circuit current of −6.54 μA, as shown by FIG. 8b. For a thin cotton textile, however, the carbon-activated thread with rubbed mode has an average open-circuit voltage of −38.3 V and the tapped mode has an open-circuit voltage of −5.55 V, while the average short-circuit current for rubbed mode is −23.63 μA, and the short-circuit current for tapped mode is −7.43 μA, shown respectively by FIGS. 8c and 8d. The rubbed mode increased both the open-circuit voltage and the short-circuit current by 7.85 and 9.34 times, respectively, compared to the tapped mode when a thick cotton textile is used. On the other hand, when a thin cotton textile was used, the rubbed mode showed higher open-circuit voltage and short-circuit current by 6.9 and 3.18 times, respectively, compared to the tapped mode. Furthermore, the carbon-activated thread on thick cotton textile increased open-circuit voltage and short-circuit current by 59% and 158.5% compared to that on thin cotton textile for rubbing mode. Table A is a summary of open-circuit voltages and short-circuit currents measured in rubbed and tapped modes. Data in Table A comes from measurements found in FIG. 8.

TABLE A

| | Thin cotton textile | Thick cotton textile |
|---|---|---|
| Open-circuit voltage in | −38.3 V | −60.9 V |
| rubbed mode | | |
| Short-circuit current in | −23.63 μA | −61.08 μA |
| rubbed mode | | |
| Open-circuit voltage in | −5.55 V | −7.76 V |
| tapped mode | | |
| Short-circuit current in | −7.43 μA | −6.54 μA |
| tapped mode | | |

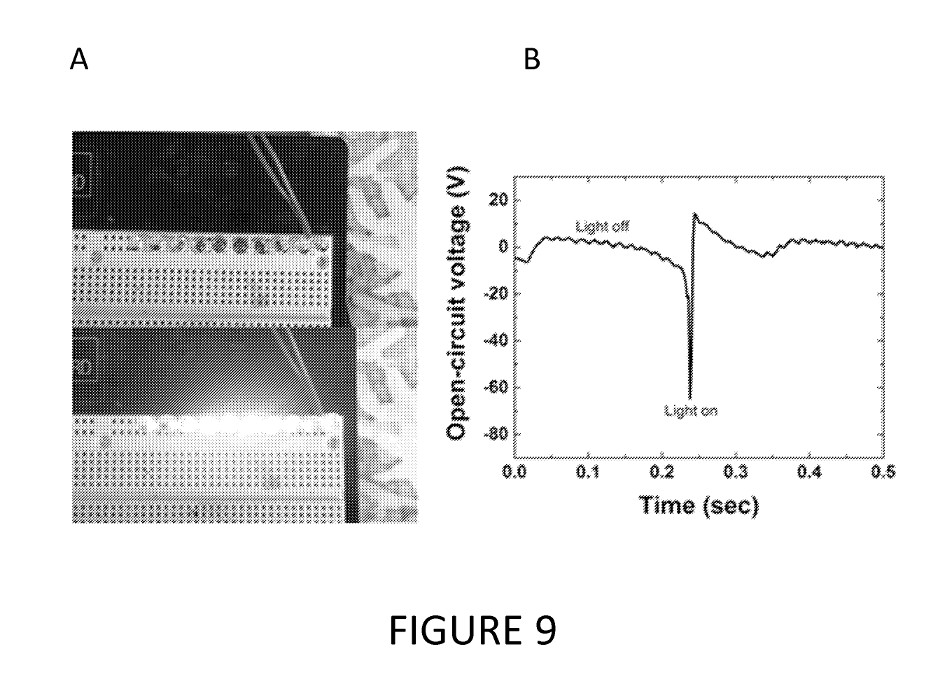

It was also confirmed that the conductivity of carbon-activated thread was maintained and the output performances were not degraded after many runs. Then, the carbon-activated thread was tested with a load of 100 M) and 10 yellow LEDs connected in parallel. When the carbon-activated thread on the cotton textile was rubbed by PTFE, all the LEDs lighted up very brightly as shown in FIG. 9.

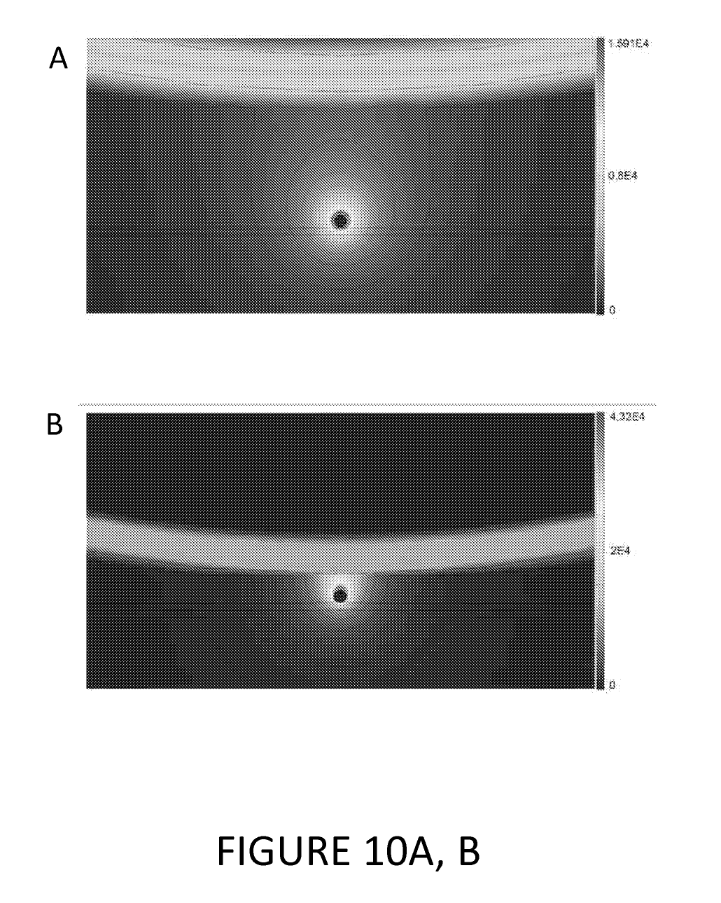

FIGS. 10a and 10b illustrate the electric field magnitudes when the gap between carbon-activated thread and PTFE is 2 cm and 2 mm, respectively. As the gap decreases, the electric field is strengthened which indicated that the accumulated charges in PTFE were affecting the carbon-activated thread. This simulation was in agreement with the asymmetric peak shape of the open-circuit voltage shown in FIG. 9b. When the PTFE sheet was brought into close proximity of the carbon active cotton thread, the decreasing distance resulted in more induced negative charges accumulating in the core of the cotton thread because the enhanced electric field attracts more positive charges on the outer shell of the thread. In this manner, free electrons flow from the PTFE sheet to the carbon active cotton thread and a negative current is produced. It is necessary to note that the rubbed mode had more charge accumulation on PTFE than the tapped mode, because more electrostatic charges are naturally produced due to the friction and increased contact area between the cotton textile and PTFE sheet. When there is contact between the PTFE sheet and carbon active cotton thread, most of the charges recombine rapidly and disappear. However, when the materials are separated, the carbon active cotton thread recovers its electrostatic charging state and small amounts of instantaneous positive current are produced. The asymmetric alternating output peak through the load can be attributed to the electrostatic charging phenomenon when the carbon active cotton thread and PTFE sheet make repeated contact and separation with each other.

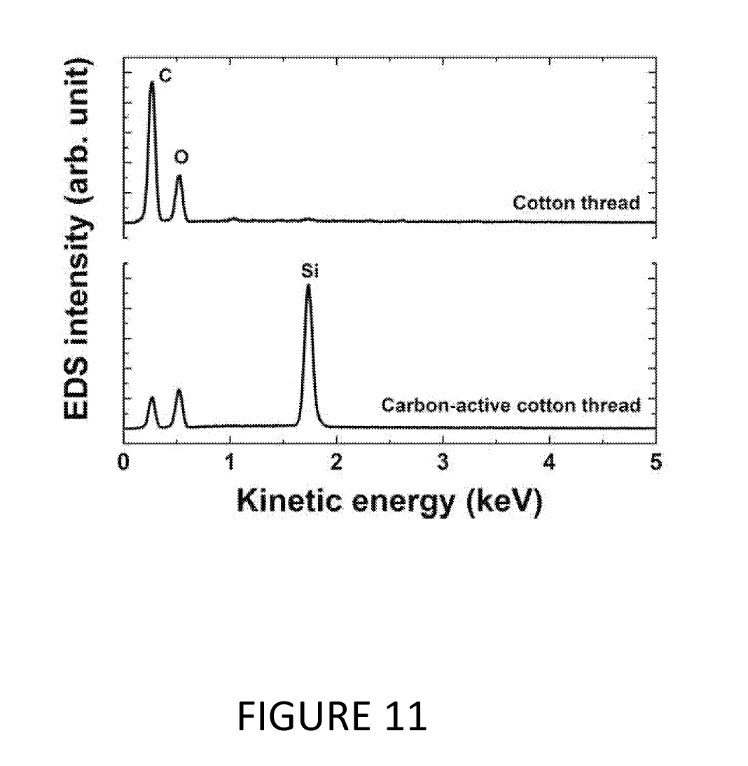

FIG. 11 shows EDS analysis of cotton thread and carbon-active cotton thread. To understand chemical compositions of normal cotton thread and carbon-activated thread, energy-dispersive x-ray spectroscopy (EDS) using Noran System Six was performed. For normal cotton thread, carbon and oxygen peaks are shown, while a silicon peak is also present for carbon-activated thread. Since cotton thread consists of cellulose fibers with the chemical formula (C₆H₁₀O₅)ₙ, C and O can be detected by EDS. However, the carbon-activated thread also includes polydimethylsiloxane (PDMS) and silicone, which are CH₃[Si(CH₃)₂O]ₙSi(CH₃)₃ and [R₂SiO]ₙ, where R is an organic group such as methyl, ethyl, or phenyl; therefore, C, O, and Si are dectectable on carbon-activated thread.

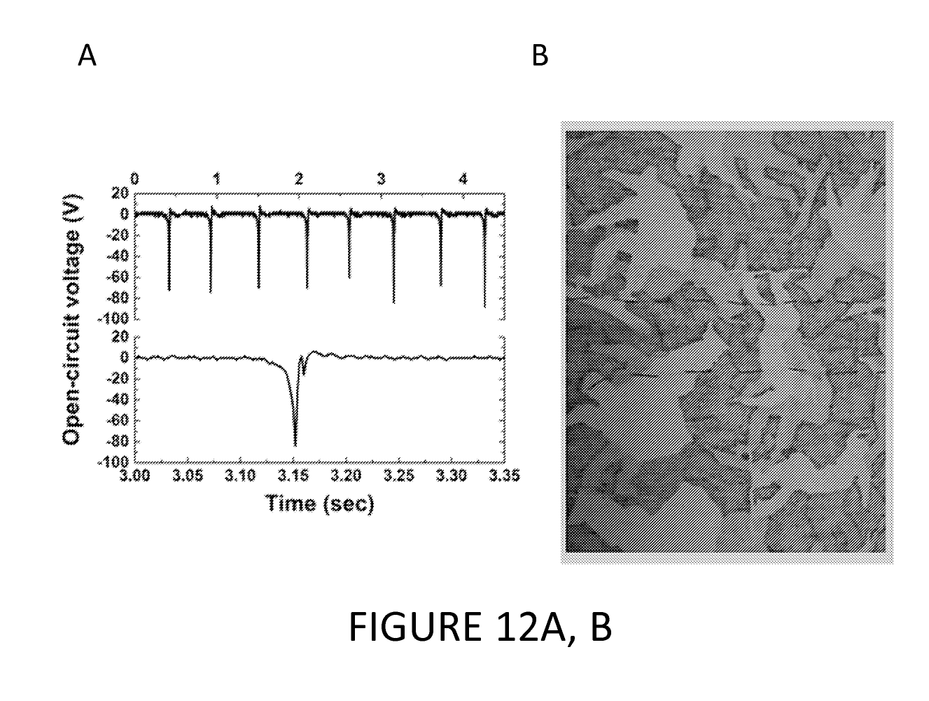

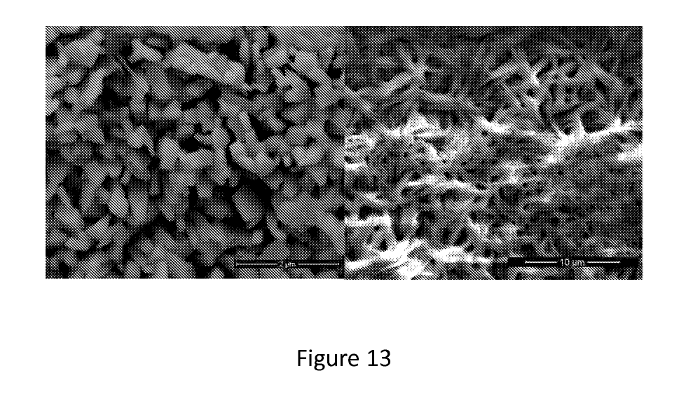

When two lines of carbon-activated thread were woven in a thick textile, the average open-circuit voltage was estimated to be −73.25 V at the main peak, and an additional smaller peak of −16 V are shown in FIG. 12a and FIG. 12b. The peak width is 0.030 sec for two lines of carbon-activated thread, while that of one carbon-activated thread line is 0.018 sec, indicating that the increasing number of carbon-activated thread lines improved output performance peak intensity by 20.3% and peak width by 66.7%.

Preparation of Carbon-Active Cotton Threads:

To fabricate the carbon active cotton thread structure using normal cotton threads with a diameter of approximately 100 μm measured by a caliper, simple coating techniques were employed. The cotton threads were cleaned with acetone, methanol, isopropyl alcohol, and de-ionized water several times. The cotton threads were then painted with a mixture of PDMS and carbon black powder with a weight ratio of 4:1 to conduct the generated electrostatic charges. Applying a thin layer of carbon black particles preserves the flexibility and elasticity of the textile threads to a great extent, which makes them ideal for application in electronic textiles. The resistance of the conductive cotton thread was measured to be about 85.1 kΩ/cm. In the final step, a commercial silicone (a mixture of ethyltriacetoxysilane and methyltriacetoxysilane) paste was applied on the thread several times and air-dried at room temperature until the carbon black did not come out. The final diameter of the carbon active cotton thread was 160 μm measured by a caliper. The diameters of normal cotton thread and carbon active cotton thread are different from those based on the SEM images because the threads could be compressed by the caliper due to their elasticity.

Assembly of Thread-Based Power Harvesters on Cotton Textiles:

While a carbon active cotton thread was woven into two separate cotton textiles with thicknesses of 240 μm and 480 μm, respectively, a PTFE sheet with thickness of 70 μm was wrapped on the outside surface of a cylinder with a diameter of 72 mm and length of 12.0 cm to minimize the contact area during testing.

Measurement Setup:

Before and after the carbon active cotton threads were woven into the textiles, the output performance of the thread-based power harvester was recorded by Tektronix TDS 1012B oscilloscope. Open-circuit voltage was measured with input impedance of a 100 MΩ resistor, and a 10 KΩ sampling resistor was employed to measure the short-circuit current.

Simulation of Electric Field:

The electric field properties between carbon active cotton threads and a cylindrical PTFE sheet were investigated with a finite element analysis (FEA) tool (COMSOL multiphysics) using the Laplace equation as the basis for static electric field analysis.

In summary, a newly developed electrostatic generator with carbon-active cotton threads was demonstrated that was easily fabricated using a simple and cost-effective coating process. The thread-based power harvester exhibited excellent high output performance when the PTFE sheet came into contact with normal cotton textile woven with carbon active cotton threads. The rubbed mode is represented by much higher output values than the tapped mode due to the increased collection of electrostatic charges in the PTFE sheet by increasing contact area between PTFE and the cotton textile. The collected charges in the PTFE sheet can induce charges within the core of carbon active cotton threads through the insulating silicone outer shell. The alternating current turned on 10 LEDs, corresponding to the rubbing of PTFE on the cotton textile woven with carbon active cotton threads. The thread-based power harvester has possible applications in collecting and using mechanical energy that is otherwise wasted during everyday movements.

It is to be noted that the term “a” or “an” entity refers to one or more of that entity; for example, “a fiber” is understood to represent one or more “fibers.” As such, the terms “a” (or “an”), “one or more,” and “at least one” can be used interchangeably herein.

Unless defined otherwise, all technical and scientific terms used herein have the same meaning as commonly understood by one of ordinary skill in the art to which this disclosure is related Units, prefixes, and symbols are denoted in their Système International de Unites (SI) accepted form. Numeric ranges are inclusive of the numbers defining the range.

The headings provided herein are not limitations of the various aspects or aspects of the disclosure, which can be had by reference to the specification as a whole.

### REFERENCES CITED

1. Greene, L. E., et al., Low-Temperature Wafer-Scale Production of ZnO Nanowire Arrays. Angewandte Chemie International Edition, 2003. 42(26): p. 3031-3034.
2. Wang, Z. L., et al., Progress in nanogenerators for portable electronics. Materials Today, 2012. 15(12): p. 532-543.
3. Xie, X. D., Q. Wang, and N. Wu, Energy harvesting from transverse ocean waves by a piezoelectric plate. International Journal of Engineering Science, 2014. 81(0): p. 41-48.
4. Klimiec, E., et al., Piezoelectric polymer films as power converters for human powered electronics. Microelectronics Reliability, 2008. 48(6): p. 897-901.
5. Lee, M., et al., A Hybrid Piezoelectric Structure for Wearable Nanogenerators. Advanced Materials, 2012. 24(13): p. 1759-1764.
6. Bai, P., et al., Integrated Multilayered Triboelectric Nanogenerator for Harvesting Biomechanical Energy from Human Motions. ACS Nano, 2013. 7(4): p. 3713-3719.
7. Zhu, G., et al., Toward Large-Scale Energy Harvesting by a Nanoparticle-Enhanced Triboelectric Nanogenerator. Nano Letters, 2013. 13(2): p. 847-853.
8. Zhu, G., et al., Power-generating shoe insole based on triboelectric nanogenerators for self-powered consumer electronics. Nano Energy, 2013. 2(5): p. 688-692.
9. Zhong, J., et al., Fiber-Based Generator for Wearable Electronics and Mobile Medication. ACS Nano, 2014.
10. Meng, B., et al., A transparent single-friction-surface triboelectric generator and self-powered touch sensor. Energy & Environmental Science, 2013. 6(11): p. 3235-3240.
11. Wang, S., L. Lin, and Z. L. Wang, Nanoscale Triboelectric-Effect-Enabled Energy Conversion for Sustainably Powering Portable Electronics. Nano Letters, 2012. 12(12): p. 6339-6346.
12. Lacks, D. J. and R. M. Sankaran, Contact electrification of insulating materials. Journal of Physics D: Applied Physics, 2011. 44(45): p. 453001.
13. X. Tao, Wearable Electronics and Photonics, CRC Press, Boca Raton, Fla., USA 2005.
14. S. Wagner, E. Bonderover, W. B. Jordan, J. C. Sturm, Electrotextiles: concepts and challenges, Int. J. Hi. Spe. Elc. Syst. 12, 391-399 (2002).
15. S. L. P. Tang, Recent developments in flexible wearable electronics for monitoring applications, Trans. Inst. Meas. Contr. 29, 283-300 (2007).
16. K. Cherenack, C. Zysset, T. Kinkeldei, N. Munzenrieder, and G. Troster, Woven electronic fibers with sensing and display functions for smart textiles, Adv. Mater. 45, 5178-5182 (2010).
17. D. Son, J. Lee, S. Qiao, R. Ghaffari, J. Kim, J, E. Lee, C. Song, S. J. Kim, D. J. Lee, S. W. Jun, S. Yang, M. Park, J. Shin, K. Do, M. Lee, K. Kang, C. S. Hwang, N. Lu, T. Hyeon, and D. H. Kim, Multifunctional wearable devices for diagnosis and therapy of movement disorders, Nature Nanotechnol. 9, 397-404 (2014).
18. J. P. Rojas, G. A. T. Servilla, M. T. Ghoneim, S. B. Inayat, S. M. Ahmed, A. M. Hussain, and M. Hussain, Transformational silicon electronics, ACS Nano 8, 1468-1474 (2014).
19. R. B. Katragadda and Y. Xu, A novel intelligent textile technology based on silicon flexible skins, Sensors and Actuators A 143, 169-174 (2008).
20. D. Marculescu, R. Marculescu, N. H. Zamora, P. Stanley-Marbell, P. K. Khosla, S. Park, S. Jayaraman, S. Jung, C. Lauterbach, W. Wever, T. Kirstein, D. Cottet, J. Grzyb, G. Tröster, M. Jones, T. Martin, and Z. Nakad, Electronic textiles: a platform for pervasive computing, Proc. IEEE 91, 1995-2018 (2003).
21. Y. H. Lee, J. S. Kim, J. Noh, I. Lee, H. J. Kim, S. Choi, J. Seo, S. Jeon, T. S. Kim, J. Y. Lee, and J. W. Choi, Wearable textile battery rechargeable by solar energy, Nano Lett. 13, 5753-5761 (2013).
22. A. Bonfiglio and D. De Rossi, Wearable monitoring systems, Springer, New York, USA 2011.
23. Z. L. Wang and J. Song, Piezoelectric nanogenerator based on zinc oxide nanowire arrays, Science 312, 242-246 (2006).
24. G. Mattana, P. Cosseddu, B. Fraboni, G. G. Malliaras, J. P. Hinestroza, and A. Bonfiglio, Organic electronics on natural cotton fibres, Org. Electron. 12, 2033-2039 (2011).
25. B. S. Shim, W. Chen, C. Doty, C. Xu, and N. A. Kotov, Smart electronic yarns and wearable fabrics for human biomonitoring made by carbon nanotube coating with polyelectrolytes, Nano Lett. 8, 4151-4157 (2008).
26. D. Wei, D. Cotton, and T. Ryhänen, All-solid-state textile batteries made from nano-emulsion conducting polymer inks for wearable electronics, Nanomater. 2, 268-274 (2012).
27. M. Pasta, F. La Mantia, L. Hu, H. D. Deshazer, and Y. Cui, Aqueous supercapacitors on conductive cotton, Nano Res. 3, 452-458 (2010).
28. X. Liu, H. Chang, Y. Li, W. T. S. Huck, and Z. Zheng, Polyelectrolyte-bridged metal/cotton hierarchical structures for highly durable conductive yarns, ACS Appl. Mater. Inter. 1, 529-535 (2010).
29. I. Wistrand, T. Lingstrom, and L. Wagberg, Preparation of electrically conducting cellulose fibres utilizing polyelectrolyte multiplayers of poly(3,4-ethylenedioxythiophene):poly(styrene sulphonate) and poly(allylamine), Eur. Polym. J. 43, 4075-4091 (2007).
30. S. N. Bhadani, M. Kumari, S. K. Sen Gupta, and G. C. Sahu, Preparation of conducting fibers via the electrochemical polymerization of pyrrole, J. Appl. Pol. Sci. 64, 1073-1077 (1997).
31. D. Knittel and E. Schollmeyer, Electrically high-conductive textiles, Synth. Met. 159, 1433-1437 (2009).
32. A. Varesano, A. Aluigi, L. Florio, and R. Fabris, Multifunctional cotton fabrics, Synth. Met. 159, 1082-1089 (2009).
33. Y. Ding, M. A. Invernale, and G. A. Sotzing, Conductivity trends of PEDOT-PSS impregnated fabric and the effect of conductivity on electrochromic textile, ACS Appl. Mater. Inter. 2, 1588-1593 (2010).
34. L. Liu, W. Oxenham, and A. F. M. Seyam, Contact electrification of polymeric surfaces, Ind. J. Fiber Text. Res. 38, 265-269 (2013).
35. C. W. Lam, J. T. James, R. McCluskey, S. Arepalli, R. L. Hunter, A review of carbon nanotube toxicity and assessment of potential occupational and environmental health risks, Crit. Rev. Toxicol. 36, 189-217 (2006).
36. M. Mardiguian, Electrostatic discharge: understand, simulate, and fix ESD problems, John Wiley & Sons, Inc., Hoboken, N.J., USA 2009.
37. O. Gallot-Lavallée, Dielectric materials and electrostatics, John Wiley & Sons, Inc., Hoboken, N.J., USA 2013.

1. An electrostatic power generation fiber comprising:
(a) a thread-shaped core that comprises a conductive component; and
(b) a charge building-inducting-tunneling layer on the core that comprises a contact electrification material;
wherein electrical charge, formed via contact electrification of the charge building-inducting-tunneling layer, travels along the core, which during electrostatic power generation the core is a constituent of an electrical network.

2. The electrostatic power generation fiber of claim 1, wherein the thread-shaped core has a maximum cross-sectional distance in a range of about 0.1 μm to about 10 cm, and wherein the conductive component has a resistivity in a range of about 0.01 Ω·cm to about 10 MΩ·cm and the conductive component comprises a conductive material selected from the group consisting of conductive metal elements, conductive metallic alloys, conductive non-metallic elements, conductive compounds, a mixtures of the foregoing, and combinations thereof.

3. (canceled)

4. The electrostatic power generation fiber of claim 2, wherein the thread-shaped core consists of the conductive component and the conductive component consists of the conductive material.

5. (canceled)

6. (canceled)

7. (canceled)

8. (canceled)

9. The electrostatic power generation fiber of claim 1, wherein the thread-shaped core is a copper wire having a circular cross-section and a diameter in a range of about 0.1 μm to about 10 cm.

10. The electrostatic power generation fiber of claim 1, wherein the thread-shaped core further comprises a substrate component to which the conductive component is secured,
wherein the substrate component is a thread having a maximum cross-sectional distance in a range of about 0.1 μm to about 10 cm, and
wherein the conductive component is particulate of a size in a range of about 1 nm to about 500 μm, and wherein the particulate is selected from the group consisting of carbon particles, carbon nanotubes, metal nanoparticles, metal nanowires, micrometer sized metal particles, conductive polymer, graphite, graphene, semiconductor, and combinations thereof.

11. (canceled)

12. (canceled)

13. (canceled)

14. (canceled)

15. The electrostatic power generation fiber of claim 10, wherein the thread comprises a thread material selected from the group consisting of natural fibers, man-made fibers, and combinations thereof.

16. (canceled)

17. (canceled)

18. The electrostatic power generation fiber of claim 15, wherein the thread material comprises discontinuous fibers having an aspect ratio in a range about 20 to 200, or continuous fibers having an aspect ratio greater than 200, or a combination of the discontinuous and continuous fibers.

19. The electrostatic power generation fiber of claim 10 wherein the thread is cotton and the particulate is carbon particles.

20. The electrostatic power generation fiber of claim 10, wherein the conductive component is secured to the substrate component with binding component, wherein the binding component is a polymer, and wherein the polymer is selected from the group consisting of poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof.

21. (canceled)

22. (canceled)

23. The electrostatic power generation fiber of claim 1, wherein the charge building-inducting-tunneling layer has a dielectric strength in the range of about 1 MV/m to about 2000 MV/m, an average thickness in a range of about 5 nm to about 1 mm; and a nano/micro scale surface morphology that comprises features of a size in a range of about 1 nm to about 500 μm, and wherein the charge building-inducting-tunneling layer further comprises pores of sizes in a range of about 1 nm to about 500 μm.

24. The electrostatic power generation fiber of claim 23, wherein the contact electrification material has a dielectric constant (∈ᵣ) in a range of about 1 to about 100 and is selected from the group consisting of poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof.

25. (canceled)

26. (canceled)

27. (canceled)

28. (canceled)

29. (canceled)

30. (canceled)

31. A textile or garment comprising at I act one a multiplicity of electrostatic power generation fibers connected in series, in parallel or both series and parallel, wherein each electrostatic power generation fiber comprises:
(a) a thread-shaped core that comprises a conductive component; and
(b) a charge building-inducting-tunneling layer on the core that comprises a contact electrification material;
wherein electrical charge, formed via contact electrification of the charge building-inducting-tunneling layer, travels along the core, which during electrostatic power generation the core is a constituent of an electrical network.

32. (canceled)

33. (canceled)

34. (canceled)

35. (canceled)

36. (canceled)

37. A method of making the textile or garment of claim 31, the method comprising weaving said multiplicity of electrostatic power generation fibers into said textile or garment.

38. A method of preparing an electrostatic power generation fiber comprising forming a charge building-inducting-tunneling layer that comprises a contact electrification material on a thread-shaped core that comprises a conductive component.

39. The method of claim 38, wherein the thread-shaped core has a maximum cross-sectional distance in a range of about 0.1 μm to about 10 cm, and wherein the conductive component has a resistivity in a range of about 0.01 Ω·cm to about 10 MΩ·cm and the conductive component comprises a conductive material selected from the group consisting of conductive metal elements, conductive metallic alloys, conductive non-metallic elements, conductive compounds, a mixtures of the foregoing, and combinations thereof.

40. (canceled)

41. The method of claim 39, wherein the thread-shaped core consists of the conductive component and the conductive component consists of the conductive material.

42. (canceled)

43. (canceled)

44. (canceled)

45. (canceled)

46. The method of claim 38, wherein the thread-shaped core is a copper wire having a circular cross-section and a diameter in a range of about 0.1 μm to about 10 cm.

47. The method of claim 38, wherein the thread-shaped core further comprises a substrate component to which the conductive component is secured,
wherein the substrate component is a thread having a maximum cross-sectional distance in a range of about 0.1 μm to about 10 cm, and
wherein the conductive component is particulate of a size in a range of about 1 nm to about 500 μm, and wherein the particulate is selected from the group consisting of carbon particles, carbon nanotubes, metal nanoparticles, metal nanowires, micrometer sized metal particles, conductive polymer, graphite, graphene, semiconductor, and combinations thereof.

48. (canceled)

49. (canceled)

50. (canceled)

51. (canceled)

52. The method of claim 47, wherein the thread comprises a thread material selected from the group consisting of natural fibers, man-made fibers, and combinations thereof.

53. (canceled)

54. (canceled)

55. The method of claim 52, wherein the thread material comprises discontinuous fibers having an aspect ratio in a range about 20 to 200, or continuous fibers having an aspect ratio greater than 200, or a combination of the discontinuous and continuous fibers.

56. The method of claim 47 wherein the thread is cotton and the particulate is carbon particles.

57. The method of claim 47, wherein the conductive component is secured to the substrate component with binding component, wherein the binding component is a polymer, and wherein the polymer is selected from the group consisting of poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof.

58. (canceled)

59. (canceled)

60. The method of claim 38, wherein the charge building-inducting-tunneling layer has a dielectric strength in the range of about 1 MV/m to about 2000 MV/m, an average thickness in a range of about 5 nm to about 1 mm; and a nano/micro scale surface morphology that comprises features of a size in a range of about 1 nm to about 500 μm, and wherein the charge building-inducting-tunneling layer further comprises pores of sizes in a range of about 1 nm to about 500 μm.

61. The electrostatic power generation fiber of claim 60, wherein the contact electrification material has a dielectric constant (∈ᵣ) in a range of about 1 to about 100 and is selected from the group consisting of poly (vinyl alcohol), poly (vinyl acetate), poly (methyl methacrylate), poly (ethylene terephthalate), polyacrylonitrile, poly (bisphenol A carbonate), poly (vinylidene chloride), polystyrene, polyethylene, polypropylene, poly (vinyl chloride) polytetrafluoroethylene, polydimethylsiloxane, copolymers of the foregoing, and combinations thereof.

62. (canceled)

63. (canceled)

64. (canceled)

65. (canceled)

66. (canceled)

67. (canceled)
